(19) United States
(12) Patent Application Publication
(10) Pub. No.: US 2021/0068475 A1
(43) Pub. Date: Mar. 11, 2021

(54) METHOD FOR PROVIDING A PADDING

(71) Applicants: CYTECH S.R.L., San Vendemiano (IT); CANNON & MACINTOSH INVESTMENT LIMITED, Valletta (MT)

(72) Inventors: Stefano COCCIA, Conegliano (IT); Francesco GARGANO, Slavonski Brod (HR)

(21) Appl. No.: 17/049,845

(22) PCT Filed: Apr. 19, 2019
(86) PCT No.: PCT/IB2019/053260

§ 371 Date: Oct. 22, 2020

(30) Foreign Application Priority Data
Apr. 24, 2018 (IT) 102018000004804

(51) Int. Cl. A41D 1/084; A41D 13/015; A41D 31/02; B33Y 10/00; B33Y 80/00; B29C 64/118

(52) U.S. Cl. CPC A41D 1/084; A41D 13/015; A41D 31/02; B33Y 10/00; B29L 2031/4857; B29C 64/118; A41D 2600/104; A41D 2500/50; B33Y 80/00

(57) ABSTRACT

A method for providing a padding relates to using 3D printing by depositing a filament according to a microarchitecture that entails the definition of superimposed matrices that are adapted to define a structure composed of individual open cells, which are mutually connected and arranged mutually opposite and side by side.

### TECHNICAL FIELD

The present disclosure relates to a method for providing a padding and a padding obtained with the method, in particular of the type that forms part of a cycling pad for cycling shorts or pants.

### BACKGROUND

Such conventional pairs of cycling shorts are usually made up of several parts, including a cycling pad made of chamois leather or of synthetic material, and are joined together in order to cover and protect the intimate parts of the cyclist, who usually does not wear underwear when he or she wears cycling shorts.

The cycling pad must therefore usually be in direct contact with the skin of the user.

In the zone where one rests on the saddle, where the greatest pressures are, it is known to place a first layer of padding, also known as a “top”, which is a flexible and elastic layer constituted by a fabric, in contact with the skin, to which, for example, a polyurethane foam of thickness comprised between one and five millimeters is added, with optional application underneath of an additional reinforcement fabric.

Reinforcement paddings can then be added to the “top”, with thickness variable between one and twenty millimeters and which occupy the central portion of the fabric, and which can be combined together to protect the areas of the cyclist's body in contact with the saddle.

These latter items can be assembled with the rest of the cycling pad via thermoforming or via high frequency or with an adhesive; it is also common and very widespread to use stitching for assembly.

One of the problems known nowadays is the effect known as “hardening of the edges of the padding”: in fact, during the manufacture of cycling pads, the padding is “joined” along its perimeter with the covering, which can be done in two ways: by stitching or by thermoforming, in which the entire perimeter of the edge of the padding is compressed and permanently deformed by using heat (at about 200° C.), and the padding is squashed against the covering and anchored with a thermo-adhesive film.

Considering that in the squashed zones the thickness is reduced from about twelve millimeters (summing the thickness of the cover and the thickness of the padding) to two millimeters, it can be seen how these “joining seams” harden the cycling pad and can create a nuisance for the cyclist.

Furthermore, conventional paddings are usually made using polyurethane foams, which have multiple drawbacks, such as a high cost of production which entails the generation of scraps or discarded material during such production, such material being classified by Italian law as hazardous waste; the high consumption of CO₂; a high cost of transport owing to the volume occupied by such foams; the use of glues or film adhesives which, with washing and use of the product with which the paddings are associated, are subject to deterioration with consequent delamination or detachment; a reduction over time of the elasticity characteristic of the material after continual use or washing, with consequent necessity to replace the entire product with which the paddings are associated; excessive localized heating owing to chafing which for example occur during use of a pair of cycling shorts with which such paddings are associated; possible skin irritations owing to the use of adhesives; difficulty in drying the product with which the paddings are associated owing to their intrinsic property of absorbing water or sweat; and finally a difficulty in obtaining, for the same padding, zones with different load-bearing capacity which can be obtained by varying the density of the foam or its thickness but which worsen the wearability, for example, of the pair of cycling shorts.

### SUMMARY

The aim of the present application is therefore to solve the above mentioned technical problems, eliminating the drawbacks in the cited known art and hence providing a method for obtaining a padding, in particular, but not exclusively, for cycling pants which makes it possible to obtain an excellent and specific protection for the user and a comfort that is constant over time.

Within the above aim, the disclosure provides a method for providing, in particular, a padding of the type belonging to a cycling pad for cycling shorts or pants which improves environmental sustainability by eliminating the use of adhesives and reducing the use of CO₂.

The disclosure also provides a method that, in addition to the above characteristic, adds that of eliminating the production of scraps or material discarded during the production, and which is simple to carry out.

The disclosure also provides a method that makes it possible to reduce the production times of the paddings.

The disclosure further provides a method that makes it possible to obtain a padding that withstands the stresses to which the product with which it is associated is subjected, and which also maintains its elasticity characteristics, even after multiple washes, and which has rapid drying times.

The disclosure obtains a method that makes it possible to obtain paddings with high breathability.

The disclosure provides a method that makes it possible to obtain a padding that has contained encumbrances and volumes for transport and a reduced overall weight.

The disclosure obtains a method that makes it possible to obtain paddings that do not retain heat and which do not overheat during their use.

The disclosure provides a method that makes it possible to obtain a padding that does not generate any kind of allergy in contact with the skin.

The disclosure obtains a method that makes it possible to provide paddings at low cost.

The disclosure obtains a method that can be carried out with the usual conventional systems.

This aim and these and other advantages which will become better apparent hereinafter are achieved by providing a method for providing a padding, which is characterized in that it uses 3D printing by depositing a filament according to a microarchitecture that entails the definition of superimposed matrices that are adapted to define a structure composed of individual open cells, which are mutually connected and arranged mutually opposite and side by side, each one having a shape in plan view with a variable diameter which is obtained by way of superimposing elements that are substantially shaped like a truncated pyramid or like a truncated cone with a polygonal base.

### BRIEF DESCRIPTION OF THE DRAWINGS

Further characteristics and advantages of the disclosure will become better apparent from the detailed description of a particular, but not exclusive, embodiment, which is illustrated by way of non-limiting example in the accompanying drawings wherein:

FIG. 1 is an exploded view, in order to render the method more intelligible, of the deposition of the first seven layers of material using different colors for a better identification thereof also in the following description;

FIG. 2 shows the deposition of a first layer;

FIG. 3 shows the deposition of a second layer on the first layer, to define a first matrix;

FIG. 4 shows the deposition of a third layer on the two preceding layers, to define a second matrix;

FIG. 5 shows the deposition of a fourth layer on the three preceding layers, to define a third matrix;

FIG. 6 shows the deposition of a fifth layer on the four preceding layers, to define a fourth matrix;

FIG. 7 shows the deposition of a sixth layer on the five preceding layers, to define a fifth matrix;

FIG. 8 shows the deposition of a seventh layer on the six preceding layers, to define a sixth matrix;

FIG. 9 is a perspective view of a series of a desired number of cells, defining the padding, which are obtained with the method;

FIG. 10 is a plan view of the padding obtained with the method;

FIG. 11 is a three-quarters side view of the padding; and

FIG. 12 is a partially cross-sectional view of FIG. 9.

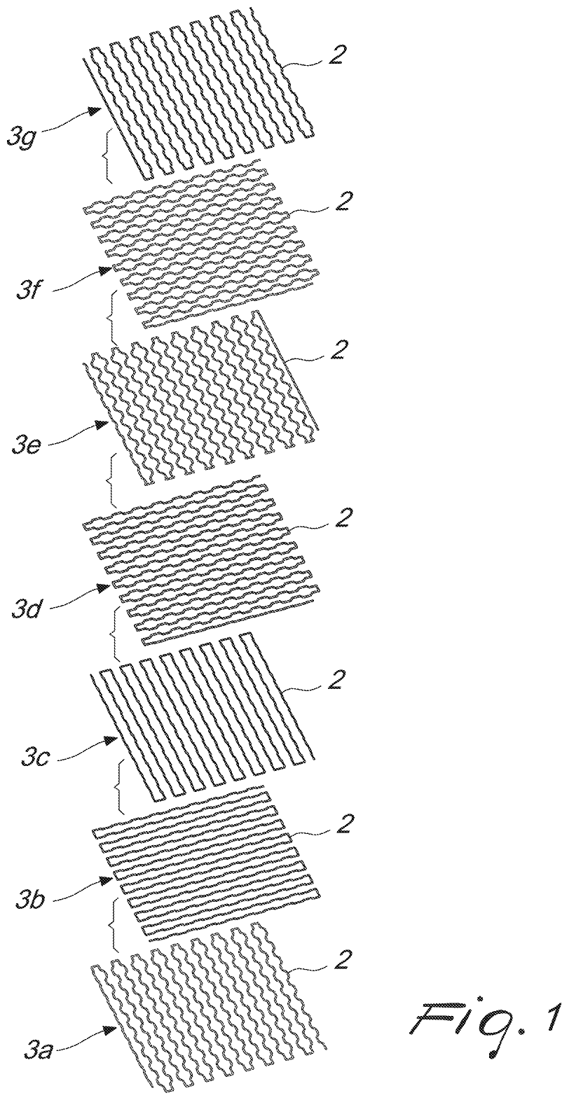

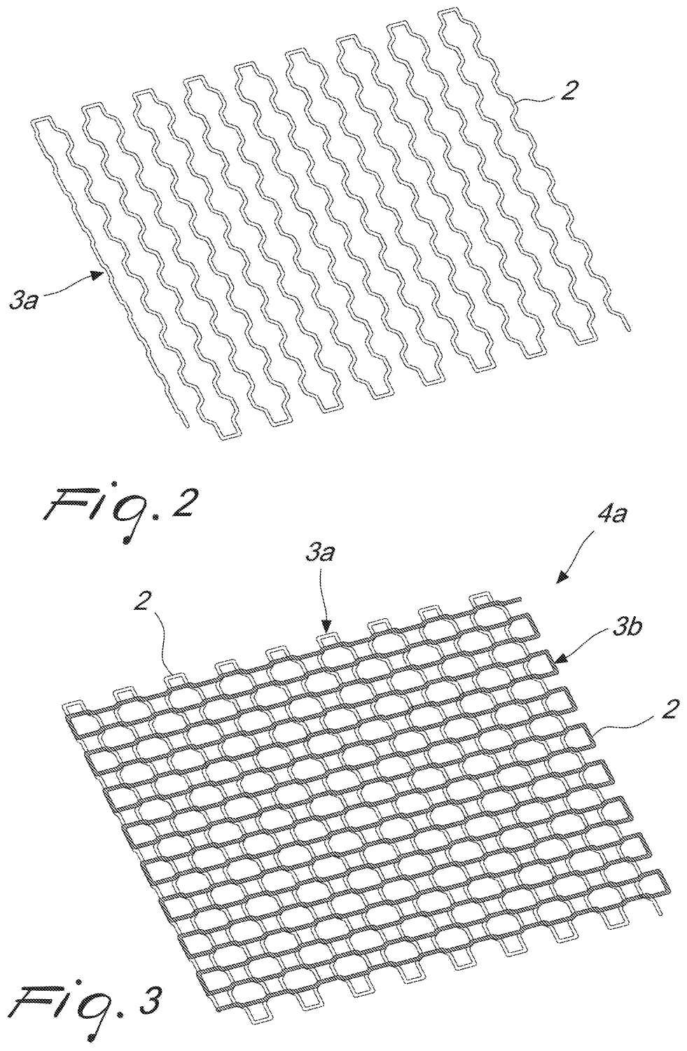

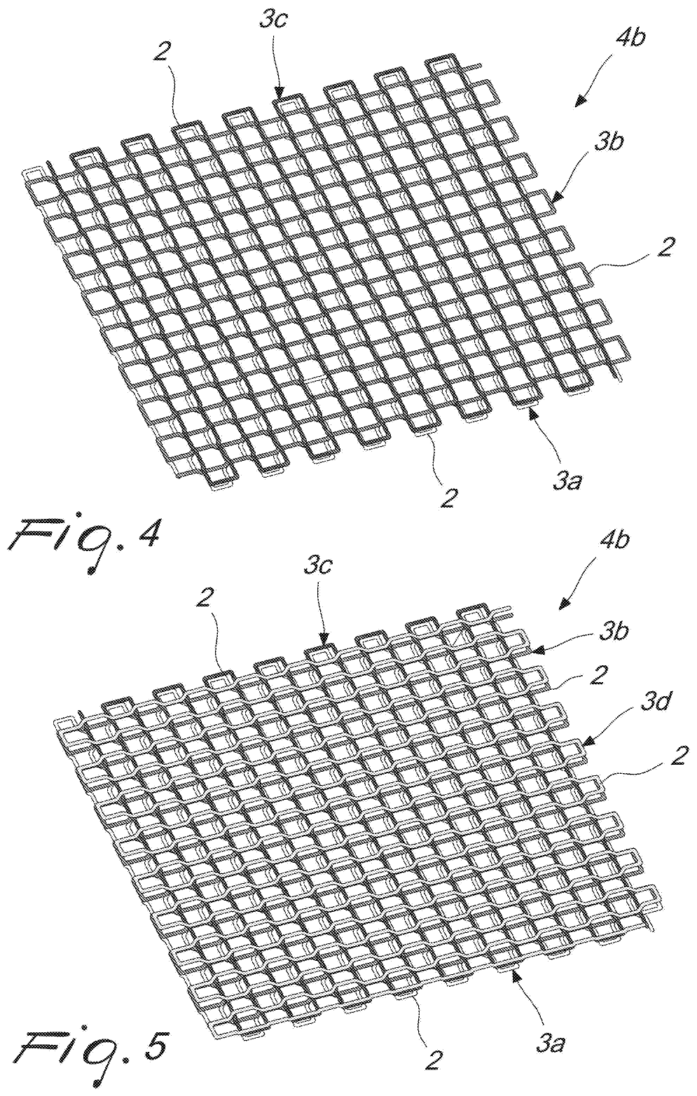

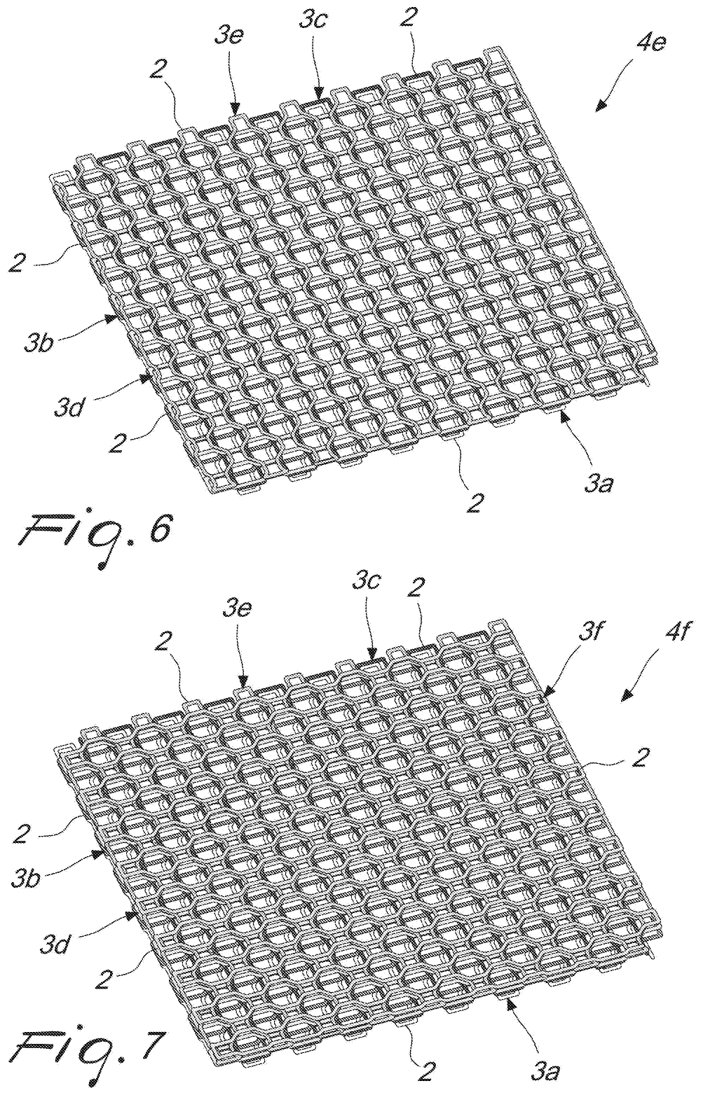

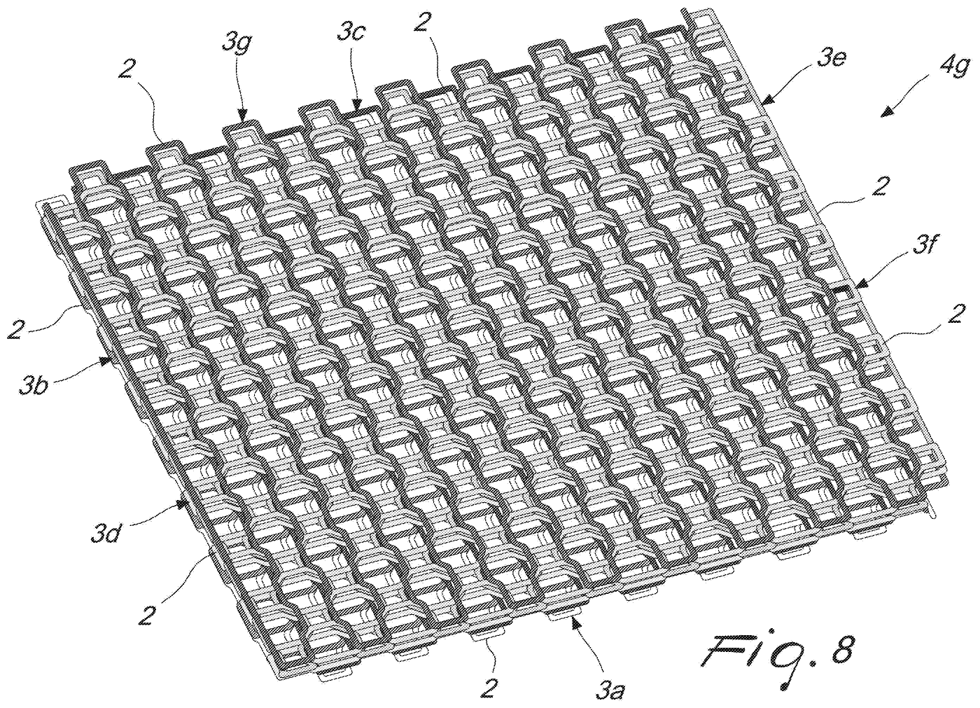

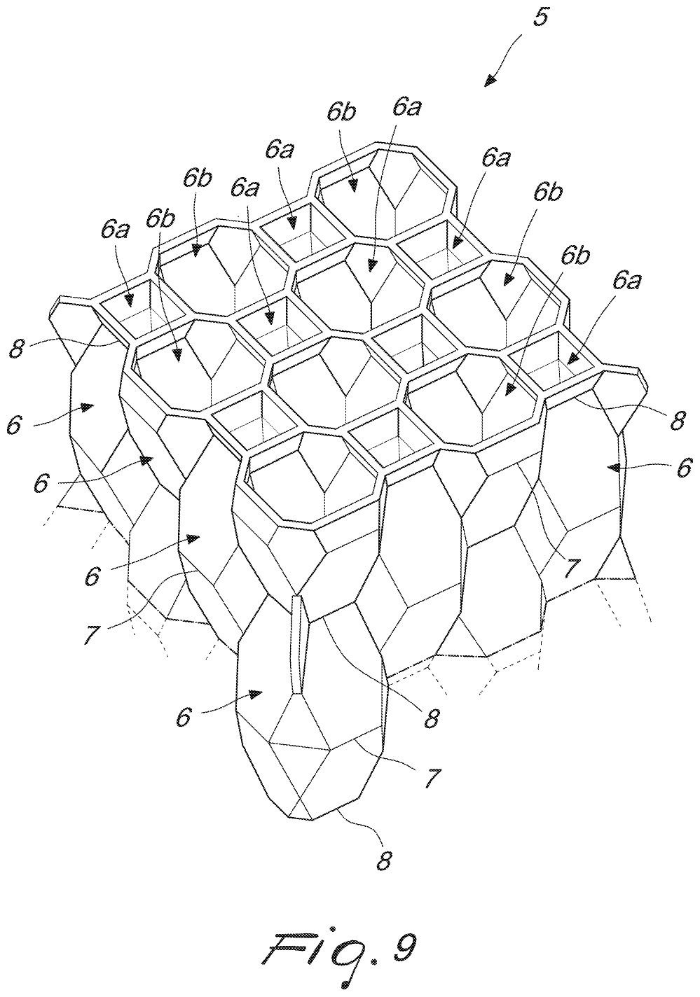

### DETAILED DESCRIPTION OF THE DRAWINGS

In the embodiments illustrated below, individual characteristics shown in relation to specific examples may in reality be interchanged with other, different characteristics, existing in other embodiments.

With reference to the figures, the method for providing a padding 1 is illustrated, in particular a padding of the type that forms part of a cycling pad for cycling shorts or pants.

The method can use one of the various conventional methods of 3D printing, as their principal differences lie in the way that the various layers are printed.

One conventional method of 3D printing consists of a system for printing material by extrusion, in which the printer creates one layer at a time, spreading for example a layer of powder (plaster or resins) and using the inkjet head to print a binder in the transverse cross-section of the part.

The process is repeated until such time as all the layers have been printed so as to obtain the product of the desired shape.

It is also known to use materials that are fused or softened in order to produce, with multiple depositions, the various layers, for example Selective Laser Sintering (SLS) and Fused Deposition Modeling (FDM).

It is also known to deposit liquid materials which are hardened with various technologies.

For providing ultra-thin configurations, it is known to use the two-photon photopolymerization 3D microfabrication technique, in which the desired 3D object is traced in a block of gel by a concentrated laser, the gel being hardened to a solid at the points where the laser has been concentrated.

Once the 3D printing method and the material that constitutes the filament 2 and its diameter have been chosen, accordingly upon taking into consideration a series of technical parameters for using the chosen material, such as, for example, the temperature, the deposition speed, and the type of nozzle to use, all of which can modify the physical characteristics of the final product, the method carries out a deposition of a filament 2 according to a very precise microarchitecture.

Among all the materials available today, the material indicated here for the deposition printing of filament, by way of non-limiting example, is distinguished by the FlexMark 8 trademark.

Naturally the materials used may be more relevant according to specific requirements.

The accompanying drawings give an example illustration of only the first seven layers 3a, 3b, 3c, 3d, 3e, 3f, 3g, which are layers that are colored differently from each other in order to identify them more easily.

The specific microarchitecture chosen for the deposition of the layers entails the definition of various matrices, for example for the first seven layers identified in sequence with the numerals 4a, 4b, 4c, 4d, 4e, 4f, which, as they are formed, are mutually superimposed and adapted to define a structure 5 composed of individual open cells 6, which are mutually connected and arranged mutually opposite and side by side.

The peculiarity of the chosen microarchitecture is that it obtains a series of open cells 6 each one of which has a shape in plan view with a diameter that varies as the cell extends upward.

As shown in the accompanying figures, each open cell 6 is obtained by depositing, in sequence, layers of filament 2 which, starting for example from the first layer 3a, has a given geometry which, in the subsequent second layer 3b, has in plan view a slightly larger dimension, and so the layers grow until, as shown in FIG. 9, the point or plane 7 of maximum dimension is reached.

Starting from such point or plane 7, the dimensions of the subsequent layers tend to decrease until the point or plane 8 is reached which presents, in plan view, the minimum dimension.

Then the dimension of the layers starts to increase again until a new point or plane 7 is reached which presents, in plan view, the maximum dimension.

Advantageously, but not exclusively, the height of the cell between the points or planes 7 and 8 is identical.

The microarchitecture creates many adjacent and mutually superimposed cells 6; advantageously it is possible to offset the adjacent open cells so that the point or plane 7 of maximum dimension in plan view of a row of open cells 6a corresponds to the point or plane 8 of minimum dimension in plan view of the adjacent row of open cells 6b, as shown in FIG. 9.

The geometry of the various layers is such as to obtain the superimposition of elements or open cells 6 that are substantially shaped like a truncated pyramid or like a truncated cone with a polygonal base, for example an octagonal base.

In the specific embodiment shown, the layers are deposited by generating matrices which, if one performs a transverse cross-section on the resulting product, show a sequence of elements which have, in plan view, a substantially square and octagonal shape and the sides of which are shared with those of the adjacent cells.

For a truncated cone shape with a polygonal, for example circular, base, the layers are deposited by generating matrices which, if one performs a transverse cross-section on the resulting product, show a sequence of elements which have, in plan view, a substantially circular shape with mutually tangent sides.

In this case the microarchitecture generates individual open cells 6, each of which has a shape in space which can be likened substantially to the shape of a cask, having zones that are more or less free from material between adjacent cells.

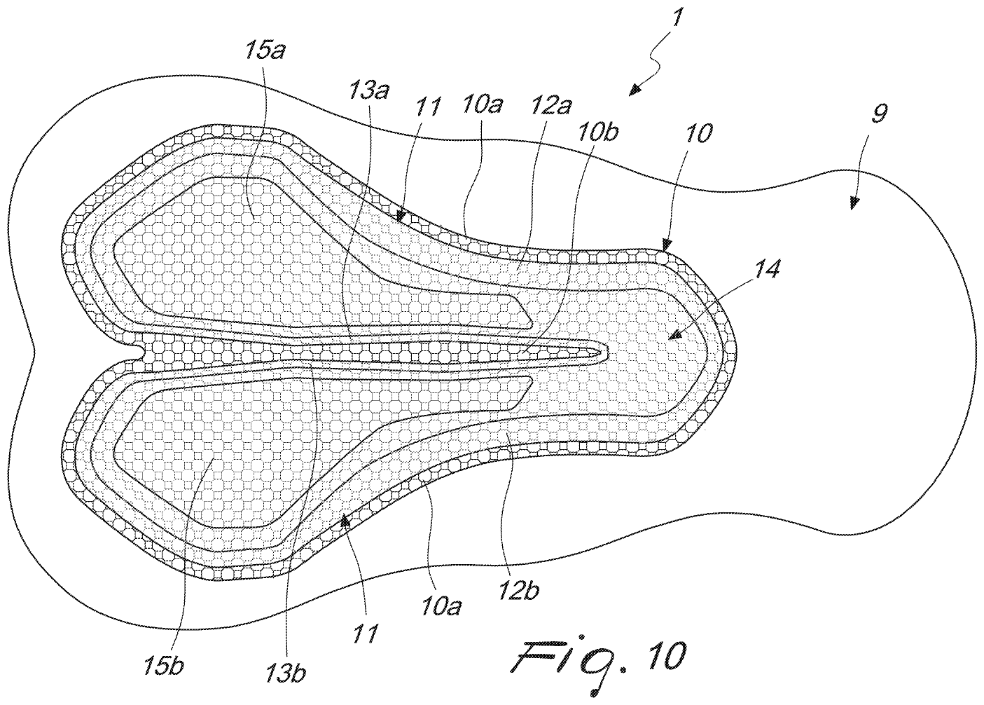

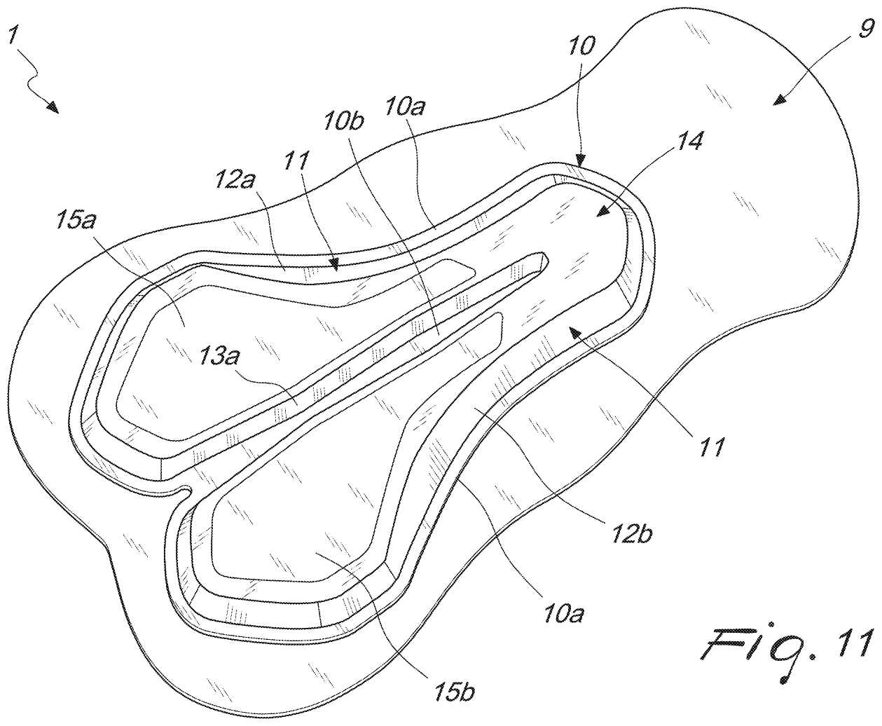

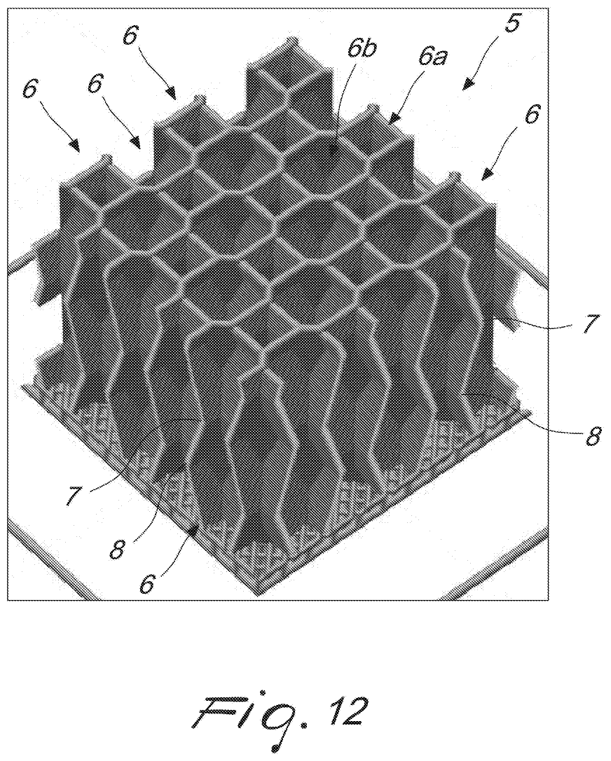

The shape and the superimposition of the individual layers is obviously carried out taking into account the shape of the product that it is desired to obtain; if it is desired to provide a padding 1, in particular a padding of the type belonging to a cycling pad for cycling shorts or pants, then, as shown in FIG. 10, a flat outer perimetric first zone 9 is obtained with a very low thickness of the cells 6, for example tending toward zero, followed by a second zone 10 with a uniform thickness of the cells 6, for example two millimeters.

Advantageously the second zone 10 is substantially heart-shaped, the perimetric edge 10a of which is blended with a substantially straight branch 10b which is arranged along the median axis of the padding 1, of a chosen thickness.

Then follows a third zone 11, which is for example V-shaped in plan view so as to define a pair of external wings 12a, 12b and a pair of internal wings 13a, 13b which are arranged substantially along the median axis of the padding 1, with a thickness of the cells 6 that increases from the perimeter toward the center in the pair of external wings 12a, 12b and a thickness that decreases from the center toward the perimeter in the pair of internal wings 13a, 13b.

Advantageously the point of maximum elevation is the same for the pair of external wings 12a, 12b and for the pair of internal wings 13a, 13b.

Then follows a fourth zone 14, which surrounds the third zone 11 with a thickness of the cells 6 that exceeds that of the third zone 11.

In the specific embodiment shown, within the fourth zone 14 there are two fifth zones 15a, 15b, which are substantially mirror-symmetrical with respect to the median axis of the padding 1, with a thickness of the cells 6 that is different from that of the adjacent fourth zone 14 and of the adjacent pair of internal wings 13a, 13b of the third zone 11.

Thus it has been found that the disclosure fully achieves the intended aim and advantages, a method having been obtained that makes it possible for example to obtain a padding, in particular, but not exclusively, for cycling pants, which has zones of differentiated thickness according to the specific requirements of the user so as to obtain an optimal and specific protection and a comfort that are constant over time, while at the same time improving environmental sustainability given that it eliminates the use of adhesives and reduces the use of CO₂.

The particular chosen shape of the microarchitecture and therefore of the cells makes it possible to achieve the characteristic of having an elastic bounce-back once a pressure thereon has ceased, the arrangement of the layers making it possible to obtain a desired density, load-bearing capacity and thickness at every desired point of the product that it is desired to obtain.

Furthermore the chosen shape of the microarchitecture makes it possible to have an optimal wearability, with an elastic bounce-back being obtained in every direction of the padding.

The use of the particular microarchitecture indicated makes it possible in fact to obtain deformable zones that at the same time are controlled and, owing to different heights of the cells, are also differentiated so as to increase the overall performance (protection and comfort) of the cycling pad, compared to conventional cycling pads, and this given that the microarchitecture indicated makes it possible to obtain a product that has characteristics, such as density, load-bearing capacity, breathability, flexibility/elasticity, and weight, which are not determined solely by the type of material used, but by the intrinsic shape of the microarchitecture.

The method further makes it possible to eliminate the production of scraps or discarded material during the production of the product and in particular of paddings, which are structurally adapted to optimally withstand the stresses to which for example the pair of cycling shorts with which they are associated are subjected.

The paddings thus obtained therefore keep their elasticity constant over time, even after multiple washes; they have rapid drying times, high breathability, contained encumbrances and volumes for transport, and reduced overall weight; and they do not trap heat, they do not overheat during use, they do not generate any type of allergy in contact with the skin, and they are of low cost.

Finally it should be noted that the method can also be used to provide, in conjunction or separately, other parts that make up the padding, in addition to the flat outer perimetric first zone 9, the second zone 10, the third zone 11, the fourth zone 14, the fifth zones 15a, 15b, or even other parts that can be combined with the padding 1, such as the covering so as to obtain a single product, i.e. the complete cycling pad or the pair of cycling shorts, but which have, for the various parts indicated, different desired characteristics and performance, for example of load-bearing capacity, in one or more desired points or zones.

This increase of load-bearing capacity is obtained for example by keeping the same microarchitecture, but applying a change in the filling, for example using the same pattern while reducing its dimensions so as to have more material and less empty space.

Naturally the materials used as well as the dimensions of the individual components of the disclosure, such as the flat outer perimetric first zone 9, the second zone 10, the third zone 11, the fourth zone 14, the fifth zones 15a, 15b may be more relevant according to specific requirements. The characteristics indicated above as advantageous, convenient or the like, may also be missing or be substituted by equivalent characteristics.

The disclosures in Italian Patent Application No. 102018000004804 from which this application claims priority are incorporated herein by reference.

1-11. (canceled)

12. A method for providing a padding, which uses 3D printing by depositing a filament according to a microarchitecture that entails the definition of superimposed matrices that are adapted to define a structure composed of individual open cells, which are mutually connected and arranged mutually opposite and side by side, each one having a shape in plan view with a variable diameter which is obtained by way of superimposing elements that are substantially shaped like a truncated pyramid or like a truncated cone with a polygonal base.

13. The method according to claim 12, wherein said microarchitecture entails the definition of various matrices which, as they are formed, are mutually superimposed and adapted to define a structure which is composed of said individual open cells, which are mutually connected and arranged mutually opposite and side by side, each one of said open cells having, in plan view, a diameter that varies as each one of said cells extends upward.

14. The method according to claim 12, wherein said microarchitecture defines cells which are obtained by depositing in sequence layers of filament which have a given geometry which, in the succession of layers, has in plan view a slightly larger dimension until a point or plane of maximum transverse dimension is reached.

15. The method according to claim 14, wherein starting from said point or plane the dimensions in plan view of the subsequent layers tend to decrease until a point of minimum transverse dimension is reached, the dimension in plan view of the subsequent layers returning to increase until a new point or plane of maximum transverse dimension is reached.

16. The method according to claim 15, wherein a height of each individual open cell between said points or planes is identical.

17. The method according to claim 15, wherein said microarchitecture creates a plurality of open cells which are mutually superimposed and in which one cell adjacent to another cell is offset so that said point or plane of minimum dimension in plan view of the adjacent row of open cells corresponds to said point or plane of maximum dimension in plan view of a row of open cells.

18. The method according to claim 13, wherein with said microarchitecture the superimposition is obtained of elements or open cells which are substantially shaped like a truncated pyramid with an octagonal base, said layers being deposited by generating matrices which, if one performs a transverse cross-section on the resulting product, show a sequence of elements which have, in plan view, a substantially square and octagonal shape and the sides of which are shared with those of the adjacent cells.

19. The method according to claim 13, wherein with said microarchitecture the superimposition is obtained of elements or open cells which are substantially shaped like a truncated cone with a polygonal or circular base, said layers being deposited by generating matrices which, if one performs a transverse cross-section on the resulting product, show a sequence of elements which have, in plan view, a substantially circular shape with mutually tangent sides so as to generate individual open cells , each of which has a shape in space which can be likened substantially to the shape of a cask, having zones that are more or less free from material between adjacent cells.

20. A padding obtained with a method according to claim 12, wherein it has a flat outer perimetric first zone with a thickness of said cells that tends toward zero, followed by a second zone with a thickness of said cells that is uniform and of higher value, said second zone being substantially heart-shaped, the perimetric edge of which being blended with a substantially straight branch which is arranged along the median axis of said padding.

21. The padding according to claim 20, wherein a third zone is adjacent to said second zone and is V-shaped in plan view so as to define a pair of external wings and a pair of internal wings which are arranged substantially along the median axis of said padding, with a thickness of said cells that increases from the perimeter toward the center in said pair of external wings and a thickness that decreases from the center toward the perimeter in said pair of internal wings, the point of maximum elevation being the same for said pair of external wings and for said pair of internal wings.

22. The padding according to claim 21, wherein a fourth zone is adjacent to said third zone and surrounds said third zone with a thickness of said cells that is greater than that in said third zone, within said fourth zone there being two fifth zones, which are substantially mirror-symmetrical with respect to the median axis of said padding, with a thickness of said cells that is different from that of said adjacent fourth zone and said adjacent pair of internal wings of said third zone.
